(19) United States
(12) Patent Application Publication
(10) Pub. No.: US 2008/0239167 A1
(43) Pub. Date: Oct. 2, 2008

(54) Remote Control of Interactive Television by Telephone

(75) Inventor: Neal Goldberg, Milpitas, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,315

(22) PCT Filed: Jan. 21, 2005
(86) PCT No.: PCT/IB2005/050253

§ 371 Date: Jul. 20, 2006

Related U.S. Application Data
(60) Provisional application No. 60/539,304, filed on Jan. 26, 2004.

(51) Int. Cl. H04N 5/44; H04N 5/445

(52) U.S. Cl. 348/734; 348/563

(57) ABSTRACT

A method and system for managing television programs are provided. Accordingly, a viewer initiates a call connection to a remote server using a telephone unit, and the server interactively issues a command signal indicative of the program desired by the viewer. The command signal is transmitted to a receiver or a television unit to display or navigate through a television program of interest to the viewer.

The present invention relates to a system and method in which selected video/audio contents are presented according to the user's preferences using a conventional telephone unit.

The modern world with a huge amount of multimedia gives television viewers a tremendous variety and range of options. Interactive television is generally controlled by a television remote control or keyboard. Techno-phobic individuals, typically characterized by the elderly population, find multi-button television remote controls, keyboards, and other pointing devices difficult to use. This challenge is due to a variety of reasons, i.e., learning hampered by overwhelming complexity in modern remote controllers, un-ergonomic small buttons, physical limitations such as poor eyesight, etc. Therefore, the present invention provides alternate means to provide the use of complex television remote controls.

The present invention is directed to a method and system for managing television programs and interactive television (iTV) applications with convenience. In particular, the present invention provides a simplified control system by providing means for a user to use conventional push buttons such as found on a conventional telephone keypad and/or an interactive voice response system to select a desired program or navigate through an iTV application.

The system includes an input device for transmitting a program request by the user, and a remote server capable of generating a command signal indicative of a program selected by the user interactively. The input device may be a conventional telephone unit, a wireless phone, or an interactive voice response system. A viewer initiates a call connection to the remote server and undergoes an authentication process, then interactively selects a program. The remote system in communication with a television unit or a receiver of the television unit transmits the command signal for displaying the program selected by the user or navigating through the iTV application.

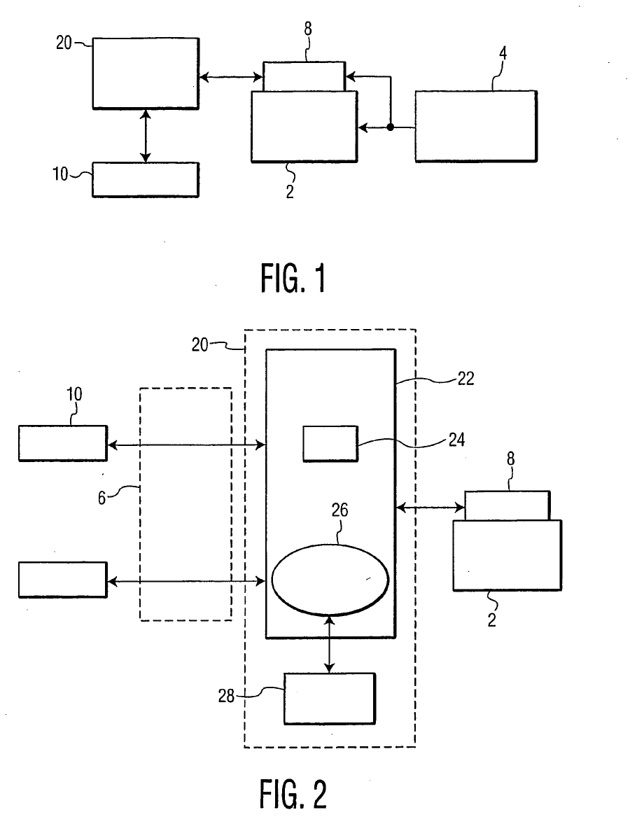

FIG. 1 is a simplified diagram of the system capable of managing television programs according an exemplary embodiment of the present invention;

FIG. 2 is another simplified diagram of the system depicted in FIG. 1;

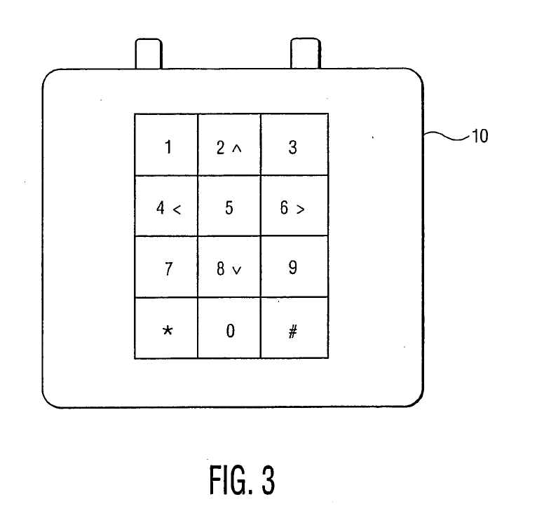

FIG. 3 is a pictorial illustration of a conventional key pad used to enable a user to manage television programs; and,

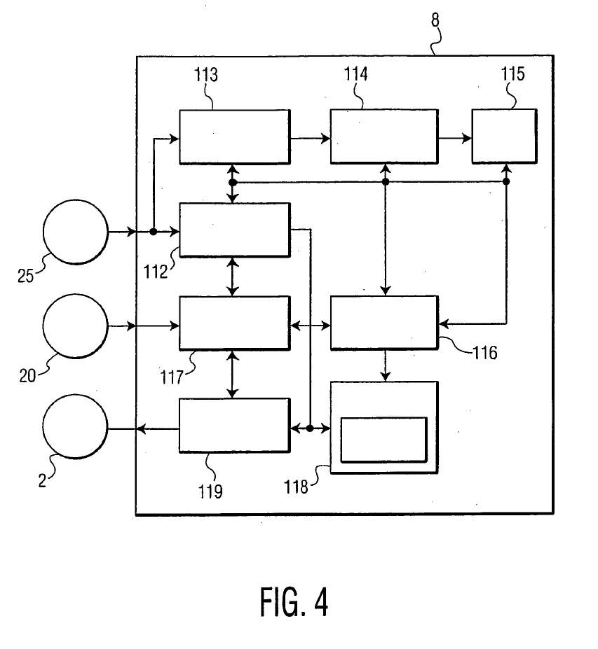

FIG. 4 is a simplified diagram of the receiver depicted in FIG. 1.

In the following description, for purposes of simplicity and clarity rather than limitation, detailed descriptions of well-known devices, circuits, and methods are omitted so as not to obscure the description of the present invention with unnecessary detail.

Referring to FIG. 1, a preferred embodiment of the present invention is a remote control system capable managing a plurality of television programs by issuing command signals to a television set 2 via a telephone set 10. As shown in FIG. 1, the television set 2 is configured to receive audio/video programming and data signals from the conventional television (TV) broadcaster 4 and/or the Internet content provider (or server). The TV programs can be delivered in analog, digital, or digitally-compressed formats via any transmission means including satellite, wireless, cable, wire, and the Web. Alternatively, the television set 2 may be coupled to a receiver 9 orset top box to receive the Internet content from a particular web server via a high-speed line, RF, conventional modern, or a two-way cable carrying the video programming or iTV application. All incoming signals, are received by the television set 2 or the receiver 8 for display. It should be noted that a receiver within the context of this disclosure includes an interactive TV/set-top box, or any duplex interactive devices. In an alternate embodiment, the television set 2 may be coupled to a telecom server 20 directly. The telecom server 20 is generally a remote computer system that is accessible via a conventional PSTN or wireless connection.

FIG. 2 illustrates a call processor 22 of the telecom server 20 depicted in FIG. 1 which controls the operation steps of the present invention. In operation, a caller places a telephone call using a phone 10 which is routed through a telephone network 6 to the telecom server 20. Note that a wireless phone may be used also in lieu of a conventional telephone unit. The data from the telephone network 6 is provided to the call processor 22 over conventional phone lines. The dialed number and other network data and/or switch data, etc., are received and analyzed by the call processor 22. The call processor 22 initiates a connection using the Interactive Voice Response (IVR) system or with associated phone lines such that the call is presented to the IVR 24 for communication or initial greeting. The IVR system is well known to those skilled in the art, thus explanation is omitted. Thereafter, the call processor 22 instructs the IVR 24 to inquire—through touch tone, voice recognition 26, or other mechanism—to validate the caller by matching the caller information with the data stored in the data storage 28. If the caller cannot be authenticated, the call processor 22 can drop the call connection. If the caller has been authenticated, the call processor 22 through use of the IVR 24 or other mechanism, such as a live agent, interacts with the caller to solicit a channel selection or other options desired by the user. The call processor 22 then sends a control signal to the receiver 8 or TV 2 to change the channel requested by the caller.

FIG. 3 illustrates the key-pad system of a typical phone unit that can be used to send signals corresponding to the desired selections of the user. Note that the caller may also send voice signals to issue desired commands.

In a normal mode, the receiver 8 or the television unit 2 receives a stream of TV programs through a variety of mediums, including a cable service provider, a satellite dish, and a conventional RF broadcast. If the viewer wishes to change channels or navigate an interactive television application without using the complex remote-control system, he or she can place a phone call to the telecom server 20. The telecom server 20 processes the incoming call from the user and, through interaction with the user, causes the receiver 8 or the television unit 2 to change the incoming programs for display. For example, after the connection, the caller is presented with a list of choices to make a channel selection. If the user wishes to watch the show “Jeopardy” the user can select button 1. The user can also browse a list of channel options by pressing a pre-specified button in the key pad of the telephone. In this manner, a user watching the TV program can select the desired program offered by the broadcaster's server. Further, arrow buttons, 2, 4, 6, and 8 can be used to browse a list of different programs available for viewing, and button 5 can be used to select the desired choice, such as recording any one of the television programs being viewed currently or any future programs for subsequent display.

The following are examples of potential interactions between the call processor 22 and the user:

### EXAMPLES

To watch channel 7, press 7 on your telephone key pad.

To watch channel 7, say “channel 7”.

To watch the UCLA-USC football game, press 1.

To select option 3, press or say 3.

To turn the television on, press 1.

To fast forward, press 6. To rewind, press 4.

To return to the electronic programming guide, press 0.

To remove the cursor up, press 2. Down press 8. Left press 4. Right press 6.

To select a choice, press #.

To record a program in channel 4 playing 7 p.m. tonight, press # and 7.

FIG. 4 depicts a pictorial representation of the receiver system 8 in accordance with the exemplary embodiment shown in FIG. 1. The receiver 8 includes a controller 112, MPEG decoder 113, a detector 114, a hard drive 115, video processor 116, channel switch 117, memory 118, and play-back section 119. It is noted that MPEG decoder 113 may comply with other MPEG standards, e.g., MPEG-1, MPEG-2, MPEG-4, and MPEG-7. The controller 112 oversees the overall operations of the receiver 8, including a view mode, record mode, play mode, and other modes that are common in the conventional set-top box.

In the operation mode, the receiver 8 receives a stream of TV programs 25 through a variety of mediums, including a cable-service provider, a satellite dish, and a conventional RF broadcast. The incoming TV programs are displayed under the control of the controller 112 during the normal mode. Meanwhile, the controller 112 causes the MPEG decoder 113 to decode the incoming TV signals, then the decoded TV signals are monitored by the detector 114 for detecting various control signals. The decoded TV signals are forwarded to the play-back section 119 for display in the television set 2, or can be stored in the hard drive 115 for subsequent retrieval if such a command signal is received from the telecom server 20. If a channel-change command is received from the telecom server 20, the channel-switch module 117 changes the current channel for viewing the corresponding TV program.

Having thus described a preferred embodiment of a method and system for managing a number of TV programs, it should be apparent to those skilled in the art that certain advantages of the system have been achieved. The foregoing is to be constructed as only being an illustrative embodiment of this invention. Persons skilled in the art can easily conceive of alternative arrangements providing a functionality that is similar to this embodiment without any deviation from the fundamental principles or the scope of this invention.

1. A method for managing a plurality of programs, the method comprising the steps of:
providing a call processor that receives a program request initiated by a user via a key-pad device;
establishing a communication channel with the key-pad device to generate a command signal indicative of a program desired by the user; and,
transmitting the command signal to a television unit for display of the program desired by the user.

2. The method of claim 1, further comprising the step of authenticating the user upon the establishment of the communication channel.

3. The method of claim 1, wherein the command signal comprises a signal to store a particular program in a storage medium.

4. The method of claim 1, wherein the plurality of programs includes at least one of a television network, Internet network, wireless network, and wired network, or a combination thereof.

5. The method of claim 1, wherein the communication channel is established by a phone-line connection.

6. The method of claim 1, wherein the communication channel is established by wireless connection.

7. The method of claim 1, wherein the display of the program is provided interactively in response to said user's input.

8. The method of claim 1, wherein the display of the program is provided interactively in response to said user's voice input.

9. A system for managing a plurality of programs, comprising:
an input device having a key pad for transmitting a program request by a user, and
a controller for generating a command signal indicative of a program selected by the user interactively and transmitting the command signal to a receiver for display.

10. The system of claim 9, wherein the controller further provides a program list selectable by the user.

11. The system of claim 9, further comprising a display device for displaying the program selected by the user.

12. The system of claim 9, wherein the display device is configured to receive incoming television programs.

13. The system of claim 9, wherein the controller is configured to authenticate the user.

14. The system of claim 9, wherein the input device comprises a plurality key buttons to selectively transmit the command signal.

15. The system of claim 9, wherein the receiver is a television unit.

16. The system of claim 9, further comprising a storage device for storing data representative of a plurality of programs corresponding to incoming television programs.

17. The system of claim 9, wherein the plurality of programs includes at least one of a television network, Internet network, wireless network, and wired network, or a combination thereof.

18. The system of claim 9, wherein the input device further comprising a voice response device for interactively transmitting a program request by a user.

19. A system for managing a plurality of programs, comprising:
a memory for storing a computer-readable code; and
a processor operatively coupled to said memory, said processor configured to:
receive a program request initiated by a user via a key-pad device;
establish a communication channel with the key-pad device to generate a command signal reflective of a program desired by the user interactively; and,
transmit the command signal to a display unit for displaying the program desired by the user.

20. The system of claim 19, wherein the controller is further configured to authenticate the user upon the establishment of the communication channel.

21. The system of claim 19, wherein the plurality of programs includes at least one of a television network, Internet network, wireless network, and wired network, or a combination thereof.
